(19) United States
(12) Patent Application Publication
(10) Pub. No.: US 2011/0258146 A1
(43) Pub. Date: Oct. 20, 2011

(54) Heat Transfer Compositions

(75) Inventor: Robert Elliott Low, Nercwys (GB)

(73) Assignee: MEXICHEM AMANCO HOLDINGS S.A. DE C.V., Viveros del Rio, Tlalnepantla (MX)

(21) Appl. No.: 13/132,057

(22) PCT Filed: Dec. 2, 2009
(86) PCT No.: PCT/GB2009/002805

§ 371 Date: Jun. 29, 2011

(30) Foreign Application Priority Data
Dec. 2, 2008 (GB) 0821924.8
Feb. 10, 2009 (GB) 0902144.5
Apr. 16, 2009 (GB) 0906549.1

(51) Int. Cl. C09K 5/04; C08J 9/14; C09K 3/30; C08F 12/08; G06Q 90/00; C08G 18/82; C11D 17/00; F25B 1/00; F25D 15/00; B01D 37/00; C09K 3/00; C08G 59/02

(52) U.S. Cl. 705/500; 252/67; 252/68; 252/182.15; 521/98; 252/182.12; 510/405; 62/498; 62/119; 165/104.11; 210/767

(57) ABSTRACT

The invention provides a heat transfer composition comprising a minimum of about 80% by weight of R-1243zf and a maximum of 20% by weight of R-32, based on the total weight of the composition.

The invention relates to heat transfer compositions, and in particular to heat transfer compositions which may be suitable as replacements for existing refrigerants such as R-134a, R-152a, R-1234yf, R-22, R-410A, R-407A, R-407B, R-407C, R507 and R-404a.

The listing or discussion of a prior-published document or any background in the specification should not necessarily be taken as an acknowledgement that a document or background is part of the state of the art or is common general knowledge.

Mechanical refrigeration systems and related heat transfer devices such as heat pumps and air-conditioning systems are well known. In such systems, a refrigerant liquid evaporates at low pressure taking heat from the surrounding zone. The resulting vapour is then compressed and passed to a condenser where it condenses and gives off heat to a second zone, the condensate being returned through an expansion valve to the evaporator, so completing the cycle. Mechanical energy required for compressing the vapour and pumping the liquid is provided by, for example, an electric motor or an internal combustion engine.

In addition to having a suitable boiling point and a high latent heat of vaporisation, the properties preferred in a refrigerant include low toxicity, non-flammability, non-corrosivity, high stability and freedom from objectionable odour. Other desirable properties are ready compressibility at pressures below 25 bars, low discharge temperature on compression, high refrigeration capacity, high efficiency (high coefficient of performance) and an evaporator pressure in excess of 1 bar at the desired evaporation temperature.

Dichlorodifluoromethane (refrigerant R-12) possesses a suitable combination of properties and was for many years the most widely used refrigerant. Due to international concern that fully and partially halogenated chlorofluorocarbons were damaging the earth's protective ozone layer, there was general agreement that their manufacture and use should be severely restricted and eventually phased out completely. The use of dichlorodifluoromethane was phased out in the 1990's.

Chlorodifluoromethane (R-22) was introduced as a replacement for R-12 because of its lower ozone depletion potential. Following concerns that R-22 is a potent greenhouse gas, its use is also being phased out.

Whilst heat transfer devices of the type to which the present invention relates are essentially closed systems, loss of refrigerant to the atmosphere can occur due to leakage during operation of the equipment or during maintenance procedures. It is important, therefore, to replace fully and partially halogenated chlorofluorocarbon refrigerants by materials having zero ozone depletion potentials.

In addition to the possibility of ozone depletion, it has been suggested that significant concentrations of halocarbon refrigerants in the atmosphere might contribute to global warming (the so-called greenhouse effect). It is desirable, therefore, to use refrigerants which have relatively short atmospheric lifetimes as a result of their ability to react with other atmospheric constituents such as hydroxyl radicals or as a result of ready degradation through photolytic processes.

R-410A and R-407 (including R-407A, R-407B and R-407C) have been introduced as a replacement refrigerant for R-22. However, R-22, R-410A and R-407 all have a high global warming potential (GWP, also known as greenhouse warming potential).

1,1,1,2-tetrafluoroethane (refrigerant R-134a) was introduced as a replacement refrigerant for R-12. However, despite having a low ozone depletion potential, R-134a has a GWP of 1300. It would be desirable to find replacements for R-134a that have a lower GWP.

R-152a (1,1-difluoroethane) has been identified as an alternative to R-134a. It is somewhat more efficient than R-134a and has a greenhouse warming potential of 120. However the flammability of R-152a is judged too high, for example to permit its safe use in mobile air conditioning systems. In particular it is believed that its lower flammable limit in air is too low, its flame speeds are too high, and its ignition energy is too low.

Thus there is a need to provide alternative refrigerants having improved properties such as low flammability. Fluorocarbon combustion chemistry is complex and unpredictable. It is not always the case that mixing a non flammable fluorocarbon with a flammable fluorocarbon reduces the flammability of the fluid. For example, the inventors have found that if non flammable R-134a is mixed with flammable R-152a, the lower flammable limit of the mixture can be reduced relative to that of pure R-152a (i.e. the mixture can be more flammable than pure R-152a). The situation is rendered more complex and less predictable if ternary or quaternary compositions are considered.

There is also a need to provide alternative refrigerants that may be used in existing devices such as refrigeration devices with little or no modification.

R-1234yf (2,3,3,3-tetrafluoropropene) has been identified as a candidate alternative refrigerant to replace R-134a in certain applications, notably the mobile air conditioning or heat pumping applications. Its GWP is about 4. R-1234yf is flammable but its flammability characteristics are generally regarded as acceptable for some applications including mobile air conditioning or heat pumping. In particular its lower flammable limit, ignition energy and flame speed are all significantly lower than that of R-152a.

The environmental impact of operating an air conditioning or refrigeration system, in terms of the emissions of greenhouse gases, should be considered with reference not only to the so-called “direct” GWP of the refrigerant, but also with reference to the so-called “indirect” emissions, meaning those emissions of carbon dioxide resulting from consumption of electricity or fuel to operate the system. Several metrics of this total GWP impact have been developed, including those known as Total Equivalent Warming Impact (TEWI) analysis, or Life-Cycle Carbon Production (LCCP) analysis. Both of these measures include estimation of the effect of refrigerant GWP and energy efficiency on overall warming impact.

The energy efficiency and refrigeration capacity of R-1234yf have been found to be significantly lower than those of R-134a and in addition the fluid has been found to exhibit increased pressure drop in system pipework and heat exchangers. A consequence of this is that to use R-1234yf and achieve energy efficiency and cooling performance equivalent to R-134a, increased complexity of equipment and increased size of pipework is required, leading to an increase in indirect emissions associated with equipment. Furthermore, the production of R-1234yf is thought to be more complex and less efficient in its use of raw materials (fluorinated and chlorinated) than R-134a. So the adoption of R-1234yf to replace R-134a will consume more raw materials and result in more indirect emissions of greenhouse gases than does R-134a.

R-1243zf is a low flammability refrigerant, and has a relatively low GWP. R-1243zf (also known as HFC1243zf) is 3,3,3-trifluoropropene (CF₃CH═CH₂). Its boiling point, critical temperature, and other properties make it a potential alternative to higher GWP refrigerants such as R-134a, R-410A and R-407. However, the properties of R-1243zf are such that it is not ideal as a direct replacement for existing refrigerants such as R-134a, R-410A and R-407. In particular, its capacity is too low, by which is meant that a refrigerator or air conditioning system having a fixed compressor displacement and designed for existing refrigerants will deliver less cooling when charged with R-1243zf and controlled to the same operating temperatures. This deficiency is in addition to its flammability, which also impacts on its suitability as a substitute for existing refrigerants when used alone.

Some existing technologies designed for R-134a may not be able to accept even the reduced flammability of some heat transfer compositions (any composition having a GWP of less than 150 is believed to be flammable to some extent).

The inventors have used the ASHRAE Standard 34 methodology at 60° C. in a 12 litre flask to determine the limiting non flammable composition of binary mixtures of R-1243zf with R-134a and R-1234yf with R-134a. It was found that a 48%/52% (weight basis) R-134a/R-1234yf mixture would be non flammable and that a 79%/21% (weight basis) R-134a/R-1243zf mixture would be non flammable. The R-1234yf mixture has a lower GWP (625) than the equivalent non flammable R-1243zf mixture and also will exhibit slightly higher volumetric capacity. However its pressure drop characteristics and cycle energy efficiency will be worse than the R-1243zf blend. It is desirable to attempt to ameliorate these effects.

A principal object of the present invention is therefore to provide a heat transfer composition which is usable in its own right or suitable as a replacement for existing refrigeration usages which should have a reduced GWP, yet have a capacity and energy efficiency (which may be conveniently expressed as the “Coefficient of Performance”) ideally within 20% of the values, for example of those attained using existing refrigerants (e.g. R-134a, R-152a, R-1234yf, R-22, R-410A, R-407A, R-407B, R-407C, R507 and R-404a), and preferably within 10% or less (e.g. about 5%) of these values. It is known in the art that differences of this order between fluids are usually resolvable by redesign of equipment and system operational features without entailing significant cost differences. The composition should also ideally have reduced toxicity and acceptable flammability.

The subject invention addresses the above deficiencies by the provision of a heat transfer composition comprising a minimum of about 80% by weight of R-1243zf and a maximum of 20% by weight of R-32, based on the total weight of the composition. These compositions are referred herein as the compositions of the invention.

Advantageously, these compositions comprise from about 80 to about 99%, preferably from about 84 to about 97%, or from about 86 to about 94%, by weight of R-1243zf, and from about 1 to about 20%, preferably from about 3 to about 16%, or from about 6 to about 14%, by weight of R-32, based on the total weight of the composition.

The compositions of the invention may contain substantially no other components. In other words, these (binary) compositions consist essentially of or consist of R-32 and R-1243zf in the amounts specified.

Examples of binary compositions include those that contain about 6/94%, 5/95%, 10/90%, 12/88% or 14/86% by weight R-32/R-1243zf. The 6/94 composition provides, for instance, a very close match to R-134a coefficient of performance. The 10/90 composition exhibits, for example, improved refrigeration capacity compared to R-134a with a temperature glide of less than 1.5K. The 14/86 composition exhibits, for instance, an advantageous combination of high refrigeration capacity and low GWP (less than 100).

All of the chemicals herein described are commercially available. For example, the fluorochemicals may be obtained from Apollo Scientific (UK).

The compositions of the invention have zero ozone depletion potential.

Surprisingly, it has been found that the compositions of the invention can deliver acceptable properties for use in air conditioning and low and medium temperature refrigeration systems as alternatives to existing refrigerants such as R-22, R-410A, R-407A, R-407B, R-407C, R507 and R-404a, while reducing GWP and without resulting in high flammability hazard.

Unless otherwise stated, as used herein “low temperature refrigeration” means refrigeration having an evaporation temperature of from about −40 to about −80° C. “Medium temperature refrigeration” means refrigeration having an evaporation temperature of from about −15 to about −40° C.

Unless otherwise stated, IPCC (Intergovernmental Panel on Climate Change) TAR (Third Assessment Report) values of GWP have been used herein. The GWP of R-1243zf has been taken as 4 in line with known atmospheric reaction rate data and by analogy with R-1234yf and R-1225ye (1,2,3,3,3-pentafluoroprop-1-ene).

The GWP of selected existing refrigerant mixtures on this basis is as follows:

| | |
|---|---|
| R-407A | 1990 |
| R-407B | 2695 |
| R-407C | 1653 |
| R-404A | 3784 |
| R507 | 3850 |

In an embodiment, the compositions of the invention have a GWP less than R-22, R-410A, R-407A, R-407B, R-407C, R507 or R-404a. Conveniently, the GWP of the compositions of the invention is less than about 3500, 3000, 2500 or 2000. For instance, the GWP may be less than 2500, 2400, 2300, 2200, 2100, 2000, 1900, 1800, 1700, 1600 or 1500.

Preferably, the compositions of the invention (e.g. those that are suitable refrigerant replacements for R-134a, R-1234yf or R-152a) have a GWP that is less than 1300, preferably less than 1000, more preferably less than 500, 400, 300 or 200, especially less than 150 or 100, even less than 50 in some cases.

Advantageously, the compositions are of reduced flammability hazard when compared to the individual flammable components of the compositions (e.g. R-1243zf). In one aspect, the compositions have one or more of (a) a higher lower flammable limit; (b) a higher ignition energy; or (c) a lower flame velocity compared to R-1243zf alone. In a preferred embodiment, the compositions of the invention are non-flammable (or inflammable).

Flammability may be determined in accordance with ASHRAE Standard 34 incorporating the ASTM Standard E-681 with test methodology as per Addendum 34p dated 2004, the entire content of which is incorporated herein by reference.

In some applications it may not be necessary for the formulation to be classed as non-flammable by the ASHRAE 34 methodology; it is possible to develop fluids whose flammability limits will be sufficiently reduced in air to render them safe for use in the application, for example if it is physically not possible to make a flammable mixture by leaking the refrigeration equipment charge into the surrounds. We have found that the effect of adding further refrigerants to flammable refrigerant R-1243zf is to modify the flammability in mixtures with air in this manner.

Temperature glide, which can be thought of as the difference between bubble point and dew point temperatures of a zeotropic (non-azeotropic) mixture at constant pressure, is a characteristic of a refrigerant; if it is desired to replace a fluid with a mixture then it is often preferable to have similar or reduced glide in the alternative fluid. In an embodiment, the compositions of the invention are zeotropic.

Conveniently, the temperature glide (in the evaporator) of the compositions of the invention is less than about 15K, for example less than about 10K or 5K.

Advantageously, the volumetric refrigeration capacity of the compositions of the invention is within about 15% of the existing refrigerant fluid it is replacing, preferably within about 10% or even about 5%.

In one embodiment, the cycle efficiency (Coefficient of Performance) of the compositions of the invention is within about 10% of the existing refrigerant fluid it is replacing, preferably within about 5% or even better than the existing refrigerant fluid it is replacing.

Conveniently, the compressor discharge temperature of the compositions of the invention is within about 15K of the existing refrigerant fluid it is replacing, preferably about 10K or even about 5K (e.g. in the case of R-407B/R-404A/R-507).

As used herein, all % amounts mentioned in compositions herein, including in the claims, are by weight based on the total weight of the compositions, unless otherwise stated.

Compositions according to the invention conveniently comprise substantially no (e.g. 0.5% or less, preferably 0.1% or less) R-1225 (pentafluoropropene), conveniently substantially no R-1225ye (1,2,3,3,3-pentafluoropropene) or R-1225zc (1,1,3,3,3-pentafluoropropene), which compounds may have associated toxicity issues.

In further aspects, the compositions of the invention do not contain any R-1234yf and/or R-134a and/or R-161 and/or R-125 and/or R-744.

The compositions of the invention preferably have energy efficiency at least 95% (preferably at least 98%) of R-134a under equivalent conditions, while having reduced or equivalent pressure drop characteristic and cooling capacity at 95% or higher of R-134a values. The compositions also advantageously have better energy efficiency and pressure drop characteristics than R-1234yf alone.

The heat transfer compositions of the invention are suitable for use in existing designs of equipment, and are compatible with all classes of lubricant currently used with established HFC refrigerants. They may be optionally stabilized or compatibilized with mineral oils by the use of appropriate additives.

Preferably, when used in heat transfer equipment, the composition of the invention is combined with a lubricant.

Conveniently, the lubricant is selected from the group consisting of mineral oil, silicone oil, polyalkyl benzenes (PABs), polyol esters (POEs), polyalkylene glycols (PAGs), polyalkylene glycol esters (PAG esters), polyvinyl ethers (PVEs), poly (alpha-olefins) and combinations thereof.

Advantageously, the lubricant further comprises a stabiliser.

Preferably, the stabiliser is selected from the group consisting of diene-based compounds, phosphates, phenol compounds and epoxides, and mixtures thereof.

Conveniently, the refrigerant composition further comprises an additional flame retardant.

Advantageously, the additional flame retardant is selected from the group consisting of tri-(2-chloroethyl)-phosphate, (chloropropyl) phosphate, tri-(2,3-dibromopropyl)-phosphate, tri-(1,3-dichloropropyl)-phosphate, diammonium phosphate, various halogenated aromatic compounds, antimony oxide, aluminium trihydrate, polyvinyl chloride, a fluorinated iodocarbon, a fluorinated bromocarbon, trifluoro iodomethane, perfluoroalkyl amines, bromo-fluoroalkyl amines and mixtures thereof.

Preferably, the heat transfer composition is a refrigerant composition.

Preferably, the heat transfer device is a refrigeration device.

Conveniently, the heat transfer device is selected from group consisting of automotive air conditioning systems, residential air conditioning systems, commercial air conditioning systems, residential refrigerator systems, residential freezer systems, commercial refrigerator systems, commercial freezer systems, chiller air conditioning systems, chiller refrigeration systems, and commercial or residential heat pump systems. Preferably, the heat transfer device is a refrigeration device or an air-conditioning system.

Advantageously, the heat transfer device contains a centrifugal-type compressor.

The invention also provides the use of a composition of the invention in a heat transfer device as herein described.

According to a further aspect of the invention, there is provided a blowing agent comprising a composition of the invention.

According to another aspect of the invention, there is provided a foamable composition comprising one or more components capable of forming foam and a composition of the invention.

Preferably, the one or more components capable of forming foam are selected from polyurethanes, thermoplastic polymers and resins, such as polystyrene, and epoxy resins.

According to a further aspect of the invention, there is provided a foam obtainable from the foamable composition of the invention.

Preferably the foam comprises a composition of the invention.

According to another aspect of the invention, there is provided a sprayable composition comprising a material to be sprayed and a propellant comprising a composition of the invention.

According to a further aspect of the invention, there is provided a method for cooling an article which comprises condensing a composition of the invention and thereafter evaporating said composition in the vicinity of the article to be cooled.

According to another aspect of the invention, there is provided a method for heating an article which comprises condensing a composition of the invention in the vicinity of the article to be heated and thereafter evaporating said composition.

According to a further aspect of the invention, there is provided a method for extracting a substance from biomass comprising contacting the biomass with a solvent comprising a composition of the invention, and separating the substance from the solvent.

According to another aspect of the invention, there is provided a method of cleaning an article comprising contacting the article with a solvent comprising a composition of the invention.

According to a further aspect of the invention, there is provided a method for extracting a material from an aqueous solution comprising contacting the aqueous solution with a solvent comprising a composition of the invention, and separating the material from the solvent.

According to another aspect of the invention, there is provided a method for extracting a material from a particulate solid matrix comprising contacting the particulate solid matrix with a solvent comprising a composition of the invention, and separating the material from the solvent.

According to a further aspect of the invention, there is provided a mechanical power generation device containing a composition of the invention.

Preferably, the mechanical power generation device is adapted to use a Rankine Cycle or modification thereof to generate work from heat.

According to another aspect of the invention, there is provided a method of retrofitting a heat transfer device comprising the step of removing an existing heat transfer fluid, and introducing a composition of the invention. Preferably, the heat transfer device is a refrigeration device or (a static) air conditioning system. Advantageously, the method further comprises the step of obtaining an allocation of greenhouse gas (e.g. carbon dioxide) emission credit.

In a further aspect of the invention, there is provided a method for reducing the environmental impact arising from operation of a product comprising an existing compound or composition, the method comprising replacing at least partially the existing compound or composition with a composition of the invention. Preferably, this method comprises the step of obtaining an allocation of greenhouse gas emission credit.

By environmental impact we include the generation and emission of greenhouse warming gases through operation of the product.

As mentioned above, this environmental impact can be considered as including not only those emissions of compounds or compositions having a significant environmental impact from leakage or other losses, but also including the emission of carbon dioxide arising from the energy consumed by the device over its working life. Such environmental impact may be quantified by the measure known as Total Equivalent Warming Impact (TEWI). This measure has been used in quantification of the environmental impact of certain stationary refrigeration and air conditioning equipment, including for example supermarket refrigeration systems (see, for example, http://en.wikipedia.orq/wiki/Total equivalent warming impact).

The environmental impact may further be considered as including the emissions of greenhouse gases arising from the synthesis and manufacture of the compounds or compositions. In this case the manufacturing emissions are added to the energy consumption and direct loss effects to yield the measure known as Life-Cycle Carbon Production (LCCP, see for example http://www.sae.orq/events/aars/presentations/2007papasavva.pdf). The use of LCCP is common in assessing environmental impact of automotive air conditioning systems.

Emission credit(s) are awarded for reducing pollutant emissions that contribute to global warming and may, for example, be banked, traded or sold. They are conventionally expressed in the equivalent amount of carbon dioxide. Thus if the emission of 1 kg of R-407A is avoided then an emission credit of 1×1990=1990 kg CO₂ equivalent may be awarded.

In another embodiment of the invention, there is provided a method for generating greenhouse gas emission credit(s) comprising (i) replacing an existing compound or composition with a composition of the invention, wherein the composition of the invention has a lower GWP than the existing compound or composition; and (ii) obtaining greenhouse gas emission credit for said replacing step.

In a preferred embodiment, the use of the composition of the invention results in the equipment having a lower Total Equivalent Warming Impact, and/or a lower Life-Cycle Carbon Production than that which would be attained by use of the existing compound or composition.

These methods may be carried out on any suitable product, for example in the fields of air-conditioning, refrigeration (e.g. low and medium temperature refrigeration), heat transfer, blowing agents, aerosols or sprayable propellants, gaseous dielectrics, cryosurgery, veterinary procedures, dental procedures, fire extinguishing, flame suppression, solvents (e.g. carriers for flavorings and fragrances), cleaners, air horns, pellet guns, topical anesthetics, and expansion applications. Preferably, the field is air-conditioning or refrigeration.

Examples of suitable products include a heat transfer devices, blowing agents, foamable compositions, sprayable compositions, solvents and mechanical power generation devices. In a preferred embodiment, the product is a heat transfer device, such as a refrigeration device or an air-conditioning unit.

The existing compound or composition has an environmental impact as measured by GWP and/or TEWI and/or LCCP that is higher than the composition of the invention which replaces it. The existing compound or composition may comprise a fluorocarbon compound, such as a perfluoro-, hydrofluoro-, chlorofluoro- or hydrochlorofluoro-carbon compound or it may comprise a fluorinated olefin

Preferably, the existing compound or composition is a heat transfer compound or composition such as a refrigerant. Examples of refrigerants that may be replaced include R-134a, R-152a, R-1234yf, R-410A, R-407A, R-407B, R-407C, R507, R-22 and R-404A.

Any amount of the existing compound or composition may be replaced so as to reduce the environmental impact. This may depend on the environmental impact of the existing compound or composition being replaced and the environmental impact of the replacement composition of the invention. Preferably, the existing compound or composition in the product is fully replaced by the composition of the invention.

The invention is illustrated by the following non-limiting Examples.

### EXAMPLES

Some R-1243zf-based compositions are set out below in table 1. Blend A is a composition of the invention. These compositions all have GWPs of less than 100. They are considered to be suitable replacements for the existing refrigerant R-134a. They are additionally considered to be suitable alternatives to the refrigerant R-1234yf.

TABLE 1
Compositions of blends expressed as weight %

| | R-32 | R-161 | R-1243zf | R-1234yf | R-134a | GWP |
|---|---|---|---|---|---|---|
| Blend A | 5 | 0 | 95 | 0 | 0 | 31 |
| Blend B | 5 | 5 | 90 | 0 | 0 | 32 |
| Blend C | 5 | 10 | 85 | 0 | 0 | 32 |
| Blend D | 10 | 5 | 85 | 0 | 0 | 59 |
| Blend E | 10 | 10 | 80 | 0 | 0 | 59 |
| Blend H | 5 | 5 | 70 | 20 | 0 | 32 |
| Blend J | 5 | 5 | 45 | 45 | 0 | 32 |
| Blend K | 5 | 5 | 20 | 70 | 0 | 32 |
| Blend L | 0 | 15 | 80 | 0 | 5 | 70 |
| Blend M | 0 | 15 | 40 | 40 | 5 | 70 |

These blends are thought to exhibit improved refrigeration performance (capacity and/or energy efficiency) relative to the pure materials R-1243zf or R-1234yf while retaining flammability characteristics that are reduced compared to pure R-161 or pure R-1243zf.

The theoretical refrigeration performance of Blends A-E and H-M was calculated using a vapour compression cycle model using the REFPROP thermodynamic property engine and compared to existing refrigerants. These calculations were performed following the standard approach as used in (for example) the INEOS Fluor “KleaCalc” software (and also may be performed using other available models for predicting the performance of refrigeration and air conditioning systems known to the skilled person in the art), using the following conditions:

| | |
|---|---|
| Mean evaporating temperature | 5° C. |
| Mean condensing temperature | 50° C. |
| Evaporator superheat | 10K |
| Condenser subcooling | 6K |
| Compressor isentropic efficiency | 67% |
| Compressor suction temperature | 15° C. |

The results are summarised in Table 2.

TABLE 2

| Results | R-134a | R-1234yf | BlendA | Blend B | Blend C | Blend D | Blend E | Blend H | Blend J | Blend K | Blend L | Blend M |
|---|---|---|---|---|---|---|---|---|---|---|---|---|
| COP | 3.41 | 3.30 | 3.40 | 3.41 | 3.42 | 3.41 | 3.41 | 3.39 | 3.36 | 3.35 | 3.43 | 3.39 |
| Volumetric capacity (kJ/m³) | 2414 | 2256 | 2334 | 2439 | 2537 | 2692 | 2788 | 2510 | 2566 | 2576 | 2397 | 2517 |
| Refrigeration effect (kJ/kg) | 148.24 | 115.44 | 156.28 | 163.61 | 170.91 | 169.31 | 176.44 | 154.44 | 144.40 | 136.76 | 171.36 | 155.37 |
| Pressure ratio | 3.77 | 3.47 | 3.62 | 3.60 | 3.57 | 3.60 | 3.58 | 3.54 | 3.48 | 3.46 | 3.53 | 3.46 |
| Compressor discharge | 76.66 | 65.84 | 74.23 | 75.58 | 76.86 | 78.19 | 79.36 | 74.26 | 72.76 | 71.51 | 75.44 | 73.37 |
| temperature (° C.) | | | | | | | | | | | | |
| Evaporator inlet pressure | 3.50 | 3.71 | 3.53 | 3.68 | 3.83 | 4.05 | 4.20 | 3.88 | 4.07 | 4.14 | 3.65 | 3.96 |
| (bara) | | | | | | | | | | | | |
| Condenser inlet pressure | 13.18 | 12.85 | 12.76 | 13.25 | 13.69 | 14.59 | 15.03 | 13.74 | 14.18 | 14.33 | 12.86 | 13.71 |
| (bara) | | | | | | | | | | | | |
| Evaporator inlet | 5.00 | 5.00 | 3.98 | 3.84 | 3.75 | 3.09 | 3.04 | 4.01 | 4.33 | 4.52 | 4.55 | 4.78 |
| temperature (° C.) | | | | | | | | | | | | |
| Evaporator dewpoint (° C.) | 5.00 | 5.00 | 6.02 | 6.16 | 6.25 | 6.91 | 6.96 | 5.99 | 5.67 | 5.48 | 5.45 | 5.22 |
| Evaporator exit gas | 15.00 | 15.00 | 16.02 | 16.16 | 16.25 | 16.91 | 16.96 | 15.99 | 15.67 | 15.48 | 15.45 | 15.22 |
| temperature (° C.) | | | | | | | | | | | | |
| Evaporator glide (out-in) | 0.0 | 0.0 | 2.0 | 2.3 | 2.5 | 3.8 | 3.9 | 2.0 | 1.3 | 1.0 | 0.9 | 0.4 |
| (K) | | | | | | | | | | | | |
| Specific suction line | 411 | 531 | 409 | 378 | 352 | 334 | 313 | 384 | 395 | 410 | 372 | 381 |
| pressure drop (kPa) | | | | | | | | | | | | |
| actual suction line pressure | 0.0 | 0.0 | 0.0 | 0.0 | 0.0 | 0.0 | 0.0 | 0.0 | 0.0 | 0.0 | 0.0 | 0.0 |
| drop | | | | | | | | | | | | |
| Compressor suction | 3.50 | 3.71 | 3.53 | 3.68 | 3.83 | 4.05 | 4.20 | 3.88 | 4.07 | 4.14 | 3.65 | 3.96 |
| pressure (bara) | | | | | | | | | | | | |
| Compressor discharge | 13.18 | 12.85 | 12.76 | 13.25 | 13.69 | 14.59 | 15.03 | 13.74 | 14.18 | 14.33 | 12.86 | 13.71 |
| pressure (bara) | | | | | | | | | | | | |
| Condenser dew point (° C. | 50.00 | 50.00 | 51.91 | 52.00 | 52.03 | 52.97 | 52.93 | 51.58 | 51.08 | 50.79 | 50.58 | 50.27 |
| Condenser bubble point | 50.00 | 50.00 | 48.09 | 48.00 | 47.97 | 47.03 | 47.07 | 48.42 | 48.91 | 49.21 | 49.42 | 49.73 |
| (° C.) | | | | | | | | | | | | |
| Condenser exit liquid | 44.00 | 44.00 | 42.09 | 42.00 | 41.97 | 41.03 | 41.07 | 42.42 | 42.91 | 43.21 | 43.42 | 43.73 |
| temperature (° C.) | | | | | | | | | | | | |
| Condenser glide (in-out) | 0.00 | 0.00 | 3.82 | 4.00 | 4.06 | 5.94 | 5.87 | 3.16 | 2.17 | 1.59 | 1.15 | 0.54 |
| (K) | | | | | | | | | | | | |

All of mixtures A-M in Table 2 exhibit improved energy efficiency and volumetric capacity relative to R-1234yf.

Furthermore they exhibit equal or lower specific suction line pressure drop as compared to either R-134a or R-1234yf. The suction line is the pipe connecting the air conditioning system evaporator to the compressor. The specific pressure drop shown is calculated assuming a common suction line diameter (16.2 mm was used in this case) and cooling duty (6.7 kW was used in this case) for each fluid. The energy efficiency of real air conditioning systems—in particular automotive air conditioners—is affected by the pressure drop in the suction line with higher pressure drops leading to reduced efficiencies. The mixtures of the invention can thus be expected to display more favourable pressure drops as compared to R-1234yf.

The mixtures of the invention also exhibit equal or reduced compressor discharge temperatures compared to R-134a.

The performance of further selected compositions of the invention was evaluated in a theoretical model of a vapour compression cycle. The model used experimentally measured data for vapour pressure and vapour liquid equilibrium behaviour of mixtures, regressed to the Peng Robinson equation of state, together with correlations for ideal gas enthalpy of each component to calculate the relevant thermodynamic properties of the fluids. The model was implemented in the Matlab software package sold in the United Kingdom by The Mathworks Ltd. The ideal gas enthalpies of R-32 and R-134a were taken from public domain measured information, namely the NIST Fluid Properties Database as exemplified by the software package “REFPROP” v8.0. Reliable estimation techniques based on the group contribution method of Joback as described in “The Properties of Gases and Liquids” 5^{th} edition by Poling et al. (which is herein incorporated by reference) were used to estimate the temperature variation of ideal gas enthalpy for the fluorinated olefins. The ideal gas heat capacity of R-1234yf and R-1225ye(Z) was also determined by measurement and these data showed that the predictions of the Joback method were of sufficient accuracy.

These calculations were performed following the standard approach as used in (for example) the INEOS Fluor “KleaCalc” software (other available models for predicting the performance of refrigeration and air conditioning systems known to the skilled person in the art may also be used), using the following conditions:

| Mean evaporating temperature: | 5° | C. |
|---|---|---|
| Mean condensing temperature: | 50° | C. |
| Evaporator superheat: | 10K | |
| Condenser subcool | 5K | |
| Evaporator pressure drop | 0 | bar |
| Suction line pressure drop | 0 | bar |
| Condenser pressure drop | 0 | bar |
| Cooling duty | 6 | kW |
| Compressor suction temperature | 15° | C. |

| | |
|---|---|
| Compressor isentropic efficiency | 67% |

The relative pressure drop characteristics of the fluids at suction line conditions were evaluated using the Darcy-Weisbach equation for incompressible fluid pressure drop, using the Colebrook relation for frictional pressure drop and assuming the following:

Constant cooling capacity (6 kW as above)
Effective internal diameter of suction pipe: 16.2 mm
Suction pipe assumed smooth internally.
Gas density evaluated at compressor suction temperature and pressure
Gas assumed incompressible
Gas viscosity taken as equivalent to that of R-134a at same temperature and pressure.

The forms of the Darcy-Weisbach and Colebrook equations were taken from the ASHRAE Handbook (2001 Fundamentals Volume) Section 2, which is herein incorporated by reference.

Table 3 shows the comparative performance for pure fluids R-1234yf, R-134a and R-1243zf.

TABLE 3

| | | R- | R- | R- |
|---|---|---|---|---|
| Property | Units | 1234yf | 134a | 1243zf |
| Pressure ratio | | 3.51 | 3.79 | 3.58 |
| Volumetric efficiency | | 90.7% | 90.2% | 90.5% |
| Condenser glide | K | 0.0 | 0.0 | 0.0 |
| Evaporator glide | K | 0.0 | 0.0 | 0.0 |
| Evaporator inlet temperature | ° C. | 5.0 | 5.0 | 5.0 |
| Condenser exit temperature | ° C. | 45.0 | 45.0 | 45.0 |
| Condenser pressure | bar a | 13.04 | 13.21 | 11.32 |
| Evaporator pressure | bar a | 3.71 | 3.48 | 3.16 |
| Refrigeration effect | kJ/kg | 117.09 | 147.70 | 148.09 |
| COP | | 3.27 | 3.36 | 3.36 |
| Discharge temperature | ° C. | 72.3 | 77.4 | 71.4 |
| Mass flow rate | kg/hr | 184 | 146 | 146 |
| Volumetric flow rate | m³/hr | 9.48 | 9.11 | 10.60 |
| Volumetric capacity | kJ/m³ | 2279 | 2372 | 2037 |
| Specific pressure drop | kPa/m | 716 | 578 | 671 |
| Pressure drop relative to R-134a | | 124% | 100% | 116% |
| Capacity relative to R-134a | | 96% | 100% | 86% |
| COP relative to R-134a | | 97% | 100% | 100% |

It can be seen that the pressure drop and capacity characteristics of both R-1243zf and R-1234yf are worse as compared to R-134a.

Performance data (calculated using the above methods) of some binary R-32/R-1243zf and ternary R-32/R-1234yf/R-1243zf blends are set out in Tables 4 to 6.

The examples are illustrative only and non-limiting. The invention is defined by the claims.

TABLE 4

| | MIXTURE PERFORMANCE - 6% R-32 | | | | | | | | | | |
|---|---|---|---|---|---|---|---|---|---|---|---|
| | (COMPOSITION IN PERCENT BY WEIGHT) | | | | | | | | | | |
| | | R-32 | | | | | | | | | |
| | | 6 | 6 | 6 | 6 | 6 | 6 | 6 | 6 | 6 | 6 |
| | | R-134a | | | | | | | | | |
| | | 0 | 0 | 0 | 0 | 0 | 0 | 0 | 0 | 0 | 0 |
| | | R-1234yf | | | | | | | | | |
| | | 0 | 10 | 20 | 30 | 40 | 50 | 60 | 70 | 80 | 94 |
| | | R-1243zf | | | | | | | | | |
| Property | Units | 94 | 84 | 74 | 64 | 54 | 44 | 34 | 24 | 14 | 0 |
| Pressure ratio | | 3.62 | 3.61 | 3.60 | 3.59 | 3.58 | 3.57 | 3.56 | 3.55 | 3.54 | 3.53 |
| Volumetric efficiency | | 90.5% | 90.6% | 90.6% | 90.6% | 90.7% | 90.7% | 90.7% | 90.8% | 90.8% | 90.8% |
| Condenser glide | K | 3.8 | 3.8 | 3.6 | 3.5 | 3.4 | 3.3 | 3.1 | 3.0 | 2.8 | 2.6 |
| Evaporator glide | K | 2.3 | 2.3 | 2.2 | 2.2 | 2.1 | 2.0 | 2.0 | 1.9 | 1.8 | 1.7 |
| Evaporator inlet temperature | ° C. | 3.9 | 3.9 | 3.9 | 3.9 | 4.0 | 4.0 | 4.0 | 4.1 | 4.1 | 4.2 |
| Condenser exit temperature | ° C. | 43.1 | 43.1 | 43.2 | 43.2 | 43.3 | 43.4 | 43.4 | 43.5 | 43.6 | 43.7 |
| Condenser pressure | bar a | 12.93 | 13.11 | 13.30 | 13.49 | 13.68 | 13.87 | 14.05 | 14.24 | 14.43 | 14.68 |
| Evaporator pressure | bar a | 3.57 | 3.63 | 3.70 | 3.76 | 3.82 | 3.89 | 3.95 | 4.01 | 4.08 | 4.16 |
| Refrigeration effect | kJ/kg | 156.40 | 153.04 | 149.71 | 146.39 | 143.10 | 139.84 | 136.62 | 133.45 | 130.34 | 126.08 |
| COP | | 3.36 | 3.35 | 3.34 | 3.33 | 3.32 | 3.32 | 3.31 | 3.30 | 3.29 | 3.27 |
| Discharge temperature | ° C. | 75.3 | 75.4 | 75.5 | 75.6 | 75.7 | 75.8 | 76.0 | 76.1 | 76.3 | 76.5 |
| Mass flow rate | kg/hr | 138 | 141 | 144 | 148 | 151 | 154 | 158 | 162 | 166 | 171 |
| Volumetric flow rate | m³/hr | 9.28 | 9.17 | 9.06 | 8.96 | 8.86 | 8.76 | 8.67 | 8.58 | 8.49 | 8.38 |
| Volumetric capacity | kJ/m³ | 2327 | 2355 | 2384 | 2411 | 2439 | 2466 | 2492 | 2519 | 2544 | 2578 |
| Specific pressure drop | kPa/m | 564 | 567 | 569 | 572 | 575 | 579 | 583 | 587 | 591 | 598 |
| Pressure drop relative to | | 98% | 98% | 99% | 99% | 100% | 100% | 101% | 102% | 102% | 104% |
| R-134a | | | | | | | | | | | |
| Capacity relative to R-134a | | 98% | 99% | 100% | 102% | 103% | 104% | 105% | 106% | 107% | 109% |
| COP relative to R-134a | | 100% | 100% | 99% | 99% | 99% | 99% | 98% | 98% | 98% | 97% |

TABLE 5

| | MIXTURE PERFORMANCE - 10% R-32 | | | | | | | | | | |
|---|---|---|---|---|---|---|---|---|---|---|---|
| | (COMPOSITION IN PERCENT BY WEIGHT) | | | | | | | | | | |
| | | R-32 | | | | | | | | | |
| | | 10% | 10% | 10% | 10% | 10% | 10% | 10% | 10% | 10% | 10% |
| | | R-134a | | | | | | | | | |
| | | 0% | 0% | 0% | 0% | 0% | 0% | 0% | 0% | 0% | 0% |
| | | R-1234yf | | | | | | | | | |
| | | 0% | 10% | 20% | 30% | 40% | 50% | 60% | 70% | 80% | 90% |
| | | R-1243zf | | | | | | | | | |
| Property | Units | 90% | 80% | 70% | 60% | 50% | 40% | 30% | 20% | 10% | 0% |
| Pressure ratio | | 3.62 | 3.61 | 3.60 | 3.59 | 3.57 | 3.56 | 3.55 | 3.54 | 3.53 | 3.53 |
| Volumetric efficiency | | 90.6% | 90.7% | 90.7% | 90.8% | 90.8% | 90.8% | 90.9% | 90.9% | 90.9% | 91.0% |
| Condenser glide | K | 5.5 | 5.4 | 5.2 | 5.0 | 4.8 | 4.6 | 4.4 | 4.1 | 3.9 | 3.8 |
| Evaporator glide | K | 3.6 | 3.5 | 3.4 | 3.3 | 3.2 | 3.1 | 2.9 | 2.8 | 2.7 | 2.5 |
| Evaporator inlet temperature | ° C. | 3.2 | 3.3 | 3.3 | 3.3 | 3.4 | 3.5 | 3.5 | 3.6 | 3.7 | 3.7 |
| Condenser exit temperature | ° C. | 42.2 | 42.3 | 42.4 | 42.5 | 42.6 | 42.7 | 42.8 | 42.9 | 43.0 | 43.1 |
| Condenser pressure | bar a | 13.96 | 14.15 | 14.35 | 14.55 | 14.74 | 14.94 | 15.14 | 15.34 | 15.53 | 15.72 |
| Evaporator pressure | bar a | 3.86 | 3.92 | 3.99 | 4.06 | 4.13 | 4.19 | 4.26 | 4.33 | 4.39 | 4.46 |
| Refrigeration effect | kJ/kg | 161.25 | 157.81 | 154.40 | 151.01 | 147.66 | 144.34 | 141.09 | 137.89 | 134.75 | 131.68 |
| COP | | 3.36 | 3.35 | 3.34 | 3.33 | 3.32 | 3.31 | 3.30 | 3.29 | 3.28 | 3.27 |
| Discharge temperature | ° C. | 77.6 | 77.7 | 77.9 | 78.0 | 78.1 | 78.3 | 78.5 | 78.6 | 78.9 | 79.1 |
| Mass flow rate | kg/hr | 134 | 137 | 140 | 143 | 146 | 150 | 153 | 157 | 160 | 164 |
| Volumetric flow rate | m³/hr | 8.58 | 8.48 | 8.38 | 8.29 | 8.20 | 8.11 | 8.02 | 7.94 | 7.87 | 7.79 |
| Volumetric capacity | kJ/m³ | 2518 | 2547 | 2577 | 2606 | 2634 | 2663 | 2692 | 2719 | 2745 | 2771 |
| Specific pressure drop | kPa/m | 509 | 512 | 514 | 517 | 520 | 523 | 527 | 531 | 535 | 539 |
| Pressure drop relative to | | 88% | 89% | 89% | 90% | 90% | 91% | 91% | 92% | 93% | 93% |
| R-134a | | | | | | | | | | | |
| Capacity relative to R-134a | | 106% | 107% | 109% | 110% | 111% | 112% | 113% | 115% | 116% | 117% |
| COP relative to R-134a | | 100% | 100% | 99% | 99% | 99% | 98% | 98% | 98% | 98% | 97% |

TABLE 6

| | MIXTURE PERFORMANCE - 12% R-32 | | | | | | | | | | |
|---|---|---|---|---|---|---|---|---|---|---|---|
| | (COMPOSITION IN PERCENT BY WEIGHT) | | | | | | | | | | |
| | | R-32 | | | | | | | | | |
| | | 12% | 12% | 12% | 12% | 12% | 12% | 12% | 12% | 12% | 12% |
| | | R-134a | | | | | | | | | |
| | | 0% | 0% | 0% | 0% | 0% | 0% | 0% | 0% | 0% | 0% |
| | | R-1234yf | | | | | | | | | |
| | | 0% | 10% | 20% | 30% | 40% | 50% | 60% | 70% | 80% | 88% |
| | | R-1243zf | | | | | | | | | |
| Property | Units | 88% | 78% | 68% | 58% | 48% | 38% | 28% | 18% | 8% | 0% |
| Pressure ratio | | 3.62 | 3.60 | 3.59 | 3.58 | 3.57 | 3.56 | 3.55 | 3.54 | 3.53 | 3.52 |
| Volumetric efficiency | | 90.7% | 90.7% | 90.8% | 90.8% | 90.9% | 90.9% | 90.9% | 91.0% | 91.0% | 91.0% |
| Condenser glide | K | 6.2 | 6.0 | 5.8 | 5.5 | 5.3 | 5.0 | 4.8 | 4.6 | 4.4 | 4.2 |
| Evaporator glide | K | 4.1 | 4.0 | 3.9 | 3.8 | 3.6 | 3.5 | 3.3 | 3.2 | 3.0 | 2.9 |
| Evaporator inlet temperature | ° C. | 2.9 | 3.0 | 3.0 | 3.1 | 3.2 | 3.3 | 3.3 | 3.4 | 3.5 | 3.6 |
| Condenser exit temperature | ° C. | 41.9 | 42.0 | 42.1 | 42.2 | 42.4 | 42.5 | 42.6 | 42.7 | 42.8 | 42.9 |
| Condenser pressure | bar a | 14.46 | 14.66 | 14.86 | 15.06 | 15.27 | 15.47 | 15.67 | 15.88 | 16.07 | 16.23 |
| Evaporator pressure | bar a | 4.00 | 4.07 | 4.14 | 4.21 | 4.28 | 4.35 | 4.42 | 4.49 | 4.55 | 4.61 |
| Refrigeration effect | kJ/kg | 163.51 | 160.04 | 156.59 | 153.17 | 149.80 | 146.47 | 143.19 | 139.99 | 136.84 | 134.39 |
| COP | | 3.36 | 3.35 | 3.34 | 3.33 | 3.32 | 3.31 | 3.30 | 3.29 | 3.28 | 3.27 |
| Discharge temperature | ° C. | 78.7 | 78.8 | 79.0 | 79.1 | 79.3 | 79.5 | 79.7 | 79.9 | 80.1 | 80.3 |
| Mass flow rate | kg/hr | 132 | 135 | 138 | 141 | 144 | 147 | 151 | 154 | 158 | 161 |
| Volumetric flow rate | m³/hr | 8.27 | 8.17 | 8.08 | 7.99 | 7.91 | 7.83 | 7.75 | 7.67 | 7.59 | 7.54 |
| Volumetric capacity | kJ/m³ | 2613 | 2643 | 2672 | 2702 | 2731 | 2760 | 2788 | 2817 | 2844 | 2865 |
| Specific pressure drop | kPa/m | 486 | 488 | 491 | 493 | 496 | 500 | 503 | 506 | 510 | 513 |
| Pressure drop relative to | | 84% | 85% | 85% | 85% | 86% | 86% | 87% | 88% | 88% | 89% |
| R-134a | | | | | | | | | | | |
| Capacity relative to R-134a | | 110% | 111% | 113% | 114% | 115% | 116% | 118% | 119% | 120% | 121% |
| COP relative to R-134a | | 100% | 100% | 99% | 99% | 99% | 98% | 98% | 98% | 98% | 97% |

1. A composition comprising a minimum of about 80% by weight of R-1243zf and a maximum of 20% by weight of R-32, based on the total weight of the composition.

2. A composition according to claim 1 comprising from about 80 to about 99%, by weight of R-1243zf, and from about 1 to about 20% by weight of R-32, based on the total weight of the composition.

3. A composition according to claim 2 comprising from about 84 to about 97%, by weight of R-1243zf, and from about 3 to about 16% by weight of R-32.

4. A composition according to claim 2 comprising from about 86 to about 94%, by weight of R-1243zf, and from about 6 to about 14% by weight of R-32.

5. A composition according to claim 1 consisting essentially of R-1243zf and R-32.

6. A composition according to claim 5 containing about 95% R-1243zf and about 5% R-32.

7. A composition according to claim 5 containing about 94% R-1243zf and about 6% R-32.

8. A composition according to claim 5 containing about 90% R-1243zf and about 10% R-32.

9. A composition according to claim 5 containing about 88% R-1243zf and about 12% R-32.

10. A composition according to claim 5 containing about 86% R-1243zf and about 14% R-32.

11. A composition according to claim 1, wherein the composition has a GWP of less than 3500, or less than 2000.

12. A composition according to claim 11, wherein the composition has a GWP of less than 1000 or less than 150.

13. A composition according to claim 1, wherein the temperature glide is less than about 15k or than about 10k.

14. A composition according to claim 1, wherein the composition has a volumetric refrigeration capacity within about 15% or within about 10% of the existing refrigerant that it is intended to replace.

15. A composition according to claim 1, wherein the composition is less flammable than R-1243zf alone.

16. A composition according to claim 15 wherein the composition has:
(a) a higher flammable limit;
(b) a higher ignition energy; and/or
(c) a lower flame velocity
compared to R-1243zf alone.

17. A composition according to claim 15 which is inflammable.

18. A composition according claim 1, wherein the composition has a cycle efficiency within about 10% of the existing refrigerant that it is intended to replace.

19. A composition according claim 1, wherein the composition has a compressor discharge temperature within about 15k, or within about 10k, of the existing refrigerant that it is intended to replace.

20. A composition according to claim 1 further comprising a lubricant.

21. A composition according to claim 20, wherein the lubricant is selected from mineral oil, silicone oil, polyalkyl benzenes (PABs), polyol esters (POEs), polyalkylene glycols (PAGs), polyalkylene glycol esters (PAG esters), polyvinyl ethers (PVEs), poly (alpha-olefins) and combinations thereof.

22. A composition according to claim 1 further comprising a stabiliser.

23. A composition according to claim 22, wherein the stabiliser is selected from diene-based compounds, phosphates, phenol compounds and epoxides, and mixtures thereof.

24. A composition according to claim 1 further comprising an additional flame retardant.

25. A composition according to claim 24, wherein the additional flame retardant is selected from the group consisting of tri-(2-chloroethyl)-phosphate, (chloropropyl) phosphate, tri-(2,3-dibromopropyl)-phosphate, tri-(1,3-dichloropropyl)-phosphate, diammonium phosphate, various halogenated aromatic compounds, antimony oxide, aluminium trihydrate, polyvinyl chloride, a fluorinated iodocarbon, a fluorinated bromocarbon, trifluoro iodomethane, perfluoroalkyl amines, bromo-fluoroalkyl amines and mixtures thereof.

26. A composition according to claim 1 in which the composition is a refrigerant composition.

27. A heat transfer device containing a composition wherein the composition comprises a minimum of about 80% by weight of R-1243zf and a maximum of 20% by weight of R-32, based on the total weight of the composition.

28. (canceled)

29. A heat transfer device according to claim 27 which is a refrigeration device.

30. A heat transfer device according to claim 29 which is selected from group consisting of automotive air conditioning systems, residential air conditioning systems, commercial air conditioning systems, residential refrigerator systems, residential freezer systems, commercial refrigerator systems, commercial freezer systems, chiller air conditioning systems, chiller refrigeration systems, and commercial or residential heat pump systems.

31. A heat transfer device according to claim 29 which contains a compressor.

32. A composition according to claim 1 in which the composition is a blowing agent.

33. A composition according to claim 1 further comprising one or more components capable of forming foam, wherein the one or more components capable of forming foam are selected from polyurethanes, thermoplastic polymers and resins and mixtures thereof.

34. A foam obtainable from a foamable composition comprising one or more components capable of forming foam and a composition comprising a minimum of about 80% by weight of R-1243zf and a maximum of 20% by weight of R-32, based on the total weight of the composition, wherein the one or more components capable of forming foam are selected from polyurethanes, thermoplastic polymers and resins and mixtures thereof.

35. A foam comprising a composition including a minimum of about 80% by weight of R-1243zf and a maximum of 20% by weight of R-32, based on the total weight of the composition.

36. A sprayable composition comprising material to be sprayed and a propellant comprising a minimum of about 80% by weight of R-1243zf and a maximum of 20% by weight of R-32, based on the total weight of the propellant.

37. A method for cooling an article which comprises condensing a composition including a minimum of about 80% by weight of R-1243zf and a maximum of 20% by weight of R-32, based on the total weight of the composition and thereafter evaporating the composition in the vicinity of the article to be cooled.

38. A method for heating an article which comprises condensing a composition including a minimum of about 80% by weight of R-1243zf and a maximum of 20% by weight of R-32, based on the total weight of the composition in the vicinity of the article to be heated and thereafter evaporating the composition.

39. A method for extracting a substance from biomass comprising contacting biomass with a solvent comprising a composition including a minimum of about 80% by weight of R-1243zf and a maximum of 20% by weight of R-32, based on the total weight of the composition, and separating the substance from the solvent.

40. A method of cleaning an article comprising contacting the article with a solvent comprising a composition including a minimum of about 80% by weight of R-1243zf and a maximum of 20% by weight of R-32, based on the total weight of the composition.

41. A method of extracting a material from an aqueous solution comprising contacting the aqueous solution with a solvent comprising a composition including a minimum of about 80% by weight of R-1243zf and a maximum of 20% by weight of R-32, based on the total weight of the composition, and separating the substance from the solvent.

42. A method for extracting a material from a particulate solid matrix comprising contacting the particulate solid matrix with a solvent comprising a composition including a minimum of about 80% by weight of R-1243zf and a maximum of 20% by weight of R-32, based on the total weight of the composition, and separating the material from the solvent.

43. A mechanical power generation device containing a composition including a minimum of about 80% by weight of R-1243zf and a maximum of 20% by weight of R-32, based on the total weight of the composition.

44. A mechanical power generating device according to claim 43 which is adapted to use a Rankine Cycle or modification thereof to generate work from heat.

45. A method of retrofitting a heat transfer device comprising the step of removing an existing heat transfer fluid, and introducing a composition including a minimum of about 80% by weight of R-1243zf and a maximum of 20% by weight of R-32, based on the total weight of the composition.

46. A method of claim 45 wherein the heat transfer device is a refrigeration device.

47. A method according to claim 46 wherein the heat transfer device is an air conditioning system.

48. A method for reducing the environmental impact arising from the operation of a product comprising an existing compound or composition, the method comprising replacing at least partially the existing compound or composition with a composition including a minimum of about 80% by weight of R-1243zf and a maximum of 20% by weight of R-32, based on the total weight of the composition.

49. A method for generating greenhouse gas emission credit comprising (i) replacing an existing compound or composition with a second composition including a minimum of about 80% by weight of R-1243zf and a maximum of 20% by weight of R-32, based on the total weight of the composition, wherein the second composition has a lower GWP than the existing compound or composition; and (ii) obtaining greenhouse gas emission credit for said replacing step.

50. A method of claim 49 wherein the use of the second composition results in a lower Total Equivalent Warming Impact, and/or a lower Life-Cycle Carbon Production than is be attained by use of the existing compound or composition.

51. A method of claim 49 carried out on a product from the fields of air-conditioning, refrigeration, heat transfer, blowing agents, aerosols or sprayable propellants, gaseous dielectrics, cryosurgery, veterinary procedures, dental procedures, fire extinguishing, flame suppression, solvents, cleaners, air horns, pellet guns, topical anesthetics, and expansion applications.

52. A method according to claim 48 wherein the product is selected from a heat transfer device, a blowing agent, a foamable composition, a sprayable composition, a solvent or a mechanical power generation device.

53. A method according to claim 52 wherein the product is a heat transfer device.

54. A method according to claim 48 wherein the existing compound or composition is a heat transfer composition.

55. A method according to claim 54 wherein the heat transfer composition is a refrigerant selected from R-22, R-410A, R-407A, R-407B, R-407C, R507 and R-404a.

56. A method according to claim 54 wherein the heat transfer composition is a refrigerant selected from R-134a, R-1234yf and R-152a.

57. (canceled)

58. A composition according to claim 33 in which the components capable for forming a foam comprise polystyrene, epoxy resins or mixtures thereof.
